(19) United States
(12) Patent Application Publication
(10) Pub. No.: US 2025/0383634 A1
(43) Pub. Date: Dec. 18, 2025

(54) CLOUD-BASED AI-ENHANCED PROCESS CONTROL SYSTEM

(71) Applicant: Saudi Arabian Oil Company, Dhahran (SA)

(72) Inventors: Abdelghani A. Daraiseh, Dhahran (SA); Soloman M. Almadi, Dhahran (SA)

(21) Appl. No.: 18/741,385

(22) Filed: Jun. 12, 2024

(51) Int. Cl. G05B 13/02

(52) U.S. Cl. CPC G05B 13/0265

(57) ABSTRACT

A control system is provided. The control system includes a cloud server with a processor, a network gateway configured to communicatively couple the cloud server to oil and gas infrastructure, and a user interface (UI). The processor is configured to receive an instruction from the UI to perform a task on a subset of the oil and gas infrastructure, wherein the instruction comprises a textual prompt that describes the task. The processor is configured to select a process control application from one or more process control applications based on the task. The processor is configured to execute the selected process control application based on i) first data specific to the subset of the oil and gas infrastructure, and ii) second data specific to the selected process control application.

### TECHNICAL FIELD

The technology relates to a cloud-based process control system applicable in oil and gas infrastructure.

### BACKGROUND

Oil and gas infrastructure typically includes equipment for various processes, such as sensing, drilling, refining, and transportation. Some pieces of equipment operate under the control of a control system, which may send instructions to the equipment electronically in a communications network.

In one aspect, a control system is provided. The control system includes a cloud server with a processor, a network gateway configured to communicatively couple the cloud server to oil and gas infrastructure, and a user interface (UI). The processor is configured to perform one or more artificial intelligence (AI)-based control operations. The operations include: receiving an instruction from the UI to perform a control task on a subset of the oil and gas infrastructure according to a process condition, wherein the instruction comprises a textual prompt that describes the control task; selecting a process control application from one or more process control applications based on the control task; executing the selected process control application based on i) first data comprising the process condition specific to the subset of the oil and gas infrastructure, and ii) second data specific to the selected process control application.

In one aspect, a method is provided. The method includes establishing communication with oil and gas infrastructure. The method includes receiving an instruction to perform a control task on a subset of the oil and gas infrastructure according to a process condition, wherein the instruction comprises a textual prompt that describes the control task. The method includes selecting a process control application from one or more process control applications based on the control task. The method includes executing the selected process control application based on a) first data comprising the process condition specific to the subset of the oil and gas infrastructure, and b) second data specific to the selected process control application. The method can be implemented as program instructions stored in a non-transitory computer-readable medium and executable by a processor.

### BRIEF DESCRIPTION OF DRAWINGS

FIG. 1 illustrates an example process control system in oil and gas infrastructure, according to some implementations.

FIGS. 2A and 2B each illustrate an example protocol stack of a process control system in oil and gas infrastructure, according to some implementations.

FIG. 3 illustrates example components of an artificial intelligence (AI)-based control management system, according to some implementations.

FIG. 4 illustrates an example matrix in a form to be displayed on a user interface (UI) of a process control system, according to some implementations.

FIG. 5 illustrates example content displayed on a UI, according to some implementations.

FIG. 6 illustrates an example database structure in a process control system, according to some implementations.

FIG. 7 illustrates a flowchart of an example method, according to some implementations.

FIG. 8 illustrates hydrocarbon production operations, according to some implementations.

Figures are not drawn to scale. Like reference numbers refer to like components.

### DETAILED DESCRIPTION

Today’s oil and gas infrastructure usually has a large amount and a wide variety of process equipment. Each piece of equipment may have its own operation parameters (e.g., process variables (PVs)), such as temperature, pressure, power, and flow rate. As the complexity of infrastructure grows, controlling the equipment becomes challenging. Current control systems often have many control sub-systems for separate pieces of equipment. Each control sub-system may have its own process control application (e.g., programs executable on computing hardware to analyze the operation status and change one or more parameters), user interface (UI) (e.g., manners of displaying information to a user and receiving instructions from the user), data storage (e.g., database of a particular implementation), historian (e.g., designated space of keeping records of past operations), signal transmission interface (e.g., cable ports for the control sub-system to exchange data with the equipment under control), and/or security policy (e.g., authentication criteria). Absent a centralized approach to manage the sub-systems and coordinate resource utilization, the operation and maintenance of a control system can be costly, inefficient, and burdensome. It is also difficult to add or remove equipment from existing infrastructure due to compatibility restrictions, resulting in lack of flexibility and scalability. Furthermore, different control sub-systems may have communication barriers due to the different UIs and/or communications protocols. These communication barriers may limit the level of automation in a control system.

This disclosure provides technical solutions to the problems. As described in detail below, implementations of this disclosure provide a cloud-based control system capable of controlling different pieces (“subsets”) of the oil and gas infrastructure in a centralized architecture. In this architecture, PVs and other operation data, which are traditionally stored separately in the sub-systems, are stored on a cloud server in a centralized manner and can be deployed by any applicable process control application of the entire control system. The PVs and the data can be clustered per each level of infrastructure hierarchy (e.g., per system, per plant, per unit, and per asset), and can be clustered per each process control application. Further, the control system according to one or more implementations allows a user to control the infrastructure from a uniform UI that is backed by generative artificial intelligence (AI). With the design of the UI and the clustering of the PVs and operation data, the control system can, with improved level of automation, deploy an application for any applicable piece of equipment according to the user’s instruction and execute the application using data from any applicable source across the infrastructure. This can allow efficient utilization of computing resources by the control system with improved flexibility and scalability.

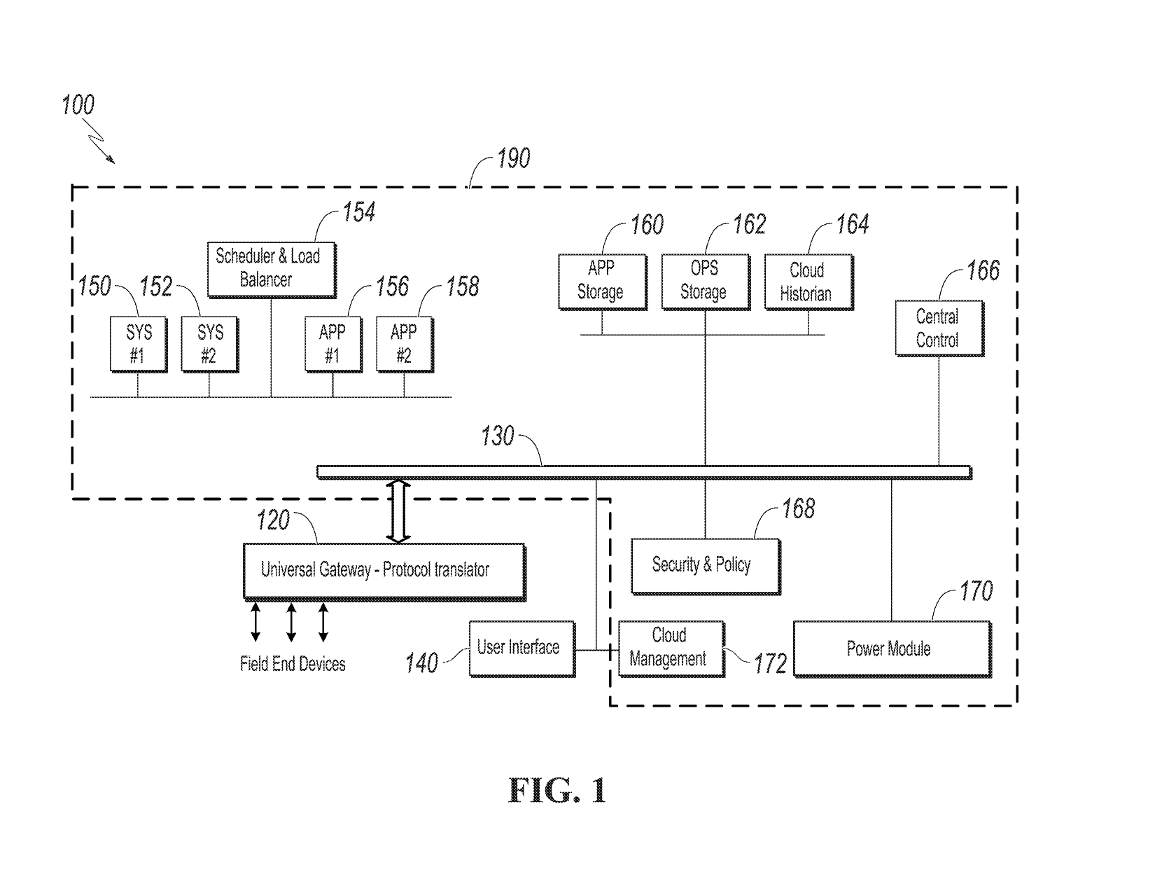

FIG. 1 illustrates an example process control system 100 in oil and gas infrastructure, according to some implementations. Typically, the control of oil and gas infrastructure can be carried out at various levels of a hierarchy. The hierarchy can include, from the top level to lower levels, a system, a plant, a unit, and an asset. A system can be a conglomerate of multiple plants, along with the flows of information, material, energy, and labor force generated or consumed by the plants. A plant can be a geographical facility where oil and gas production, processing, or consumption takes place. A unit can be one or more pieces of equipment that together carry out a specific production task at a plant. An asset can be a subset, part, or component of a unit that performs certain functions to support the unit. The process control can apply to the entire oil and gas infrastructure or a subset of the entire oil and gas infrastructure. For example, a control system or a user via the control system can send one or more instructions to control one or more systems as a subset of the entire oil and gas infrastructure, send one or more instructions to control one or more plants as a subset of a selected system, send one or more instructions to control one or more units as a subset of a selected plant, or send one or more instructions to control one or more assets as a subset of a selected unit. The user or the control system can send the control instructions from a control facility, such as a building, that is located at a distance from the field where the equipment of oil and gas production, processing, or consumption is located.

A typical process control system in oil and gas infrastructure has many elements and functions. Example elements and functions include: distributed control systems (DCS) that provide real-time monitoring, control, and data acquisition capabilities; user interface (UI) or human-machine interface (HMI); advanced process control systems configured to optimize plant operations by adjusting control parameters to improve efficiency, reduce energy consumption, and maximize yields; data historians that capture, store, and retrieve historical process data for analysis, reporting, and regulatory compliance; safety instrumented systems (SIS) that use sensors, logic solvers, and final control elements to detect unsafe conditions and initiate appropriate responses; cybersecurity measures, such as network segmentation, firewalls, intrusion detection systems, authentication mechanisms, and regular security audits; networking, ports and communication infrastructure, which provide connections between various components of the control system; integration with enterprise systems, which allows for seamless data exchange between process control systems and business functions, such as inventory management, production planning, and asset maintenance; and supervisory control and data acquisition (SCADA) systems, which provide centralized monitoring and control of remote equipment and processes. Other technologies, such as Foundation Fieldbus (FF) H1 and Highway Addressable Remote Transducer (HART), are also commonly used in process control systems for oil and gas infrastructure.

Different from many existing process control systems that implement certain control and power management functions on field end devices (e.g., sensors on oil and gas equipment) located away from a control facility, system 100 virtualizes the functions and implement the functions in a cloud server 190. Cloud server 190 can be flexibly located in fixed facilities (e.g., a server room) or moving facilities (e.g., a vehicle) at a remote position from the field end devices. Cloud server 190 can implement AI functionalities as described below. Thus, cloud server 190 is also referred to as cloud-AI server 190 in this disclosure.

Cloud-AI server 190 can be communicatively coupled to the field end devices and other components of the oil and gas infrastructure via universal gateway 120, which manages the control dataflows in a variety of communication protocols to and from cloud server 190. For example, universal gateway 120 can receive data in different formats (e.g., FIELDBUS, MODBUS, SP100, WIFI, or WIRELESSHART) from multiple sources of the oil and gas infrastructure and convert the data into standard ETHERNET data to be processed by cloud-AI server 190.

System 100 has communication bus 130 that communicatively couples cloud-AI server 190 to universal gateway 120 and communicatively couples various modules or components of cloud-AI server 190. Physically, communication bus 130 can be implemented completely or partially within the hardware of cloud-AI server 190. In some implementations, communication bus 130 supports standard highspeed data communication protocols such as ETHERNET, BIZTALK, AZURE, IBM B2B INTEGRATOR, or SAP PROCESS INTEGRATION PROCESS ORCHESTRATION.

System 100 also has UI 140 communicatively coupled to communication bus 130. UI 140 can include one or more display devices configured to display information based on data received from cloud-AI server 190 via communication bus 130. UI 140 can also include one or more input devices configured to receive instructions from a user (e.g., an operator of system 100) and transmit the instructions to cloud-AI server 190. UI 140 can be physically separate from cloud-AI server 190, attached to cloud-AI server 190, or within cloud-AI server 190. In some implementations, UI 140 can establish one or more wired or wireless connections directly with cloud-AI server 190. For example, as illustrated in FIG. 1, UI 140 is directly connected to cloud management module 172 of cloud-AI server 190 without intervening communication bus 130. UI 140 can be configured to allow access to cloud-AI server 190 depending on the role of the user. For example, UI 140 can grant access only to users with authorization, such as plant operators, maintenance personnel, engineering team members, and inspectors.

Cloud-AI server 190 has a variety of hardware and software components to perform a variety of functions. These components can include system-level computing modules (SYS) 150 and 152, such as natural gas liquid (NGL) units or gas-oil separation plant (GOSP) units, configured to run computing programs to control an entire system. The SYS components can offer versatility and scalability for use across similar units within the plant. These components can also include asset-level computing modules (APP) 156 and 158, such as boiler process control units or hydrocracker process control units, configured to run process control applications to control certain assets within a system. The APP components can be scalable and adaptable for use across similar assets within the plant. For example, a particular APP (e.g., AI-based or non-AI based) can be reused for similar assets in the plant to improve the utilization of CPU resources. Because the processors can be shared across applications (as opposed to exclusively designated to an application), the utilization of the processors can be improved.

Cloud-AI server 190 can have scheduler and/or load balancer 154 configured to execute one or more SYS or APP virtual functions to schedule performance of a control task and/or perform load balancing on the oil and gas infrastructure. The scheduler can decide the timing and delivery time of periodic and non-periodic control signals to the field end devices based on a control scheme. The scheduling can be conducted individually for each computing module SYS and APP. When a computing module SYS or APP experiences control signal delay due to, e.g., high CPU use, the scheduler and the load balancer can redistribute the computing task (“load”) to another SYS or APP to reduce CPU congestion. The scheduler and the load balancer can redistribute the load when one or more computing modules SYS or APP are out of service.

Alternatively or additionally, cloud-AI server 190 includes central control module 166 configured to edit and change control strategy for APPs 156 and 158 and for SYSs 150 and 152, or do combined control for a particular asset or system.

Alternatively or additionally, cloud-AI server 190 includes security and policy module 168, which can be configured to manage information and data security, data governance, and access control policies. Security and policy module 168 can safeguard sensitive data of the oil and gas infrastructure and ensure compliance with industry regulations and internal policies.

Alternatively or additionally, cloud-AI server 190 includes power module 170, which can be configured to regulate power sources, provide backup power, and protect cloud-AI server 190 and/or oil and gas infrastructure against undesirable power incidents, such as power interruption, power surges, circuitry shorts, and lightning strikes. Power module 170 can be used to facilitate fail-over to the backup power is case of power failure.

Alternatively or additionally, cloud-AI server 190 includes cloud management module 172, which can be configured to oversee various cloud operations. These operations can include, e.g., redundancy management, virtualization, load balancing, diagnostics, monitoring, alarm management, environmental and temperature control, cloud optimization, and performance and reliability optimization.

Alternatively or additionally, cloud-AI server 190 includes one or more data storage devices, such as memory circuits. As illustrated, the data storage devices include APP storage 160, operational (OPS) storage 162, and cloud historian 164. APP storage 160 also can be referred to as module storage 160. APP storage 160, OPS storage 162, and cloud historian 164 can be implemented in software as one or more databases.

APP storage 160 stores process control data by organizing the data into blocks per level of infrastructure (e.g., system, plant, or asset) and/or per application. For example, data specific to the same system can be stored within the same block; within that block, data pertaining to the same plant can be stored in the same sub-block, and so forth for data pertaining to the same unit and asset. Likewise, data specific to the same process control application can be stored in the same block. The data stored in APP storage 160 can be static data, e.g., data that remains unchanged during the operation of a system, plant, unit, or asset or during the execution of a process control application.

OPS storage 162 stores operations data and variables also by organizing the data into blocks per system, application, or asset. Different from APP storage 160 that stores static data, OPS storage 162 can store dynamic data that undergo frequent changes during the operation of a system, plant, unit, or asset or during the execution of a process control application. This way, a user can access and update the data in OPS storage 162 in real-time.

Cloud historian 164 stores historical and critical operational data, such as process variables and trends over time. The data stored by cloud historian 164 can be categorized according to the application and system corresponding to the data. This can enable a user to perform comprehensive analysis of past performance of a system or an process control application, obtain trend information, and make predictions for future performance.

The way cloud-AI server 190 stores data in APP storage 160, OPS storage 162, and cloud historian 164 has advantages. As described above, data specific to the same subset of the oil and gas infrastructure (e.g., data specific to the same system, same plant, or same unit) are stored together on cloud-AI server 190. Similarly, data specific to the same process control application are stored together on cloud-AI server 190. This is different from existing approaches that store data locally at each individual control system or application (e.g. one local storage for motor control system, one local storage for the boiler control system, one local storage for the hydrocracker unit, etc.) that they do not communicate or share information between each other, and do not share resources between each other. With data now stored on cloud-AI server 190 in a centralized manner, it is more convenient to remotely manage the generation, access, and update of the data, and more convenient to allocate computing resources for various process control applications. Further, it is now possible for the control system to make control when knowing the status of all control subsystems and all process variables. Moreover, the process control applications, now stored on cloud-AI server 190 with data sources also on cloud-AI server 190, can be reused for a variety of oil and gas infrastructure. For example, cloud-AI server 190 can perform motor failure prediction on multiple units located at different plants by executing the same process control application based data specific to the different plants. Compared to existing approaches in which each plant needs to execute a separate process control application locally, the cloud-based approach could streamline the process control flow and reduce resource consumption.

All of the components of cloud-AI server 190 mentioned above can be implemented as hardware circuitry, virtualized software packages, or a combination of both. It is possible that cloud-AI server 190 in some implementations has more or fewer components than illustrated.

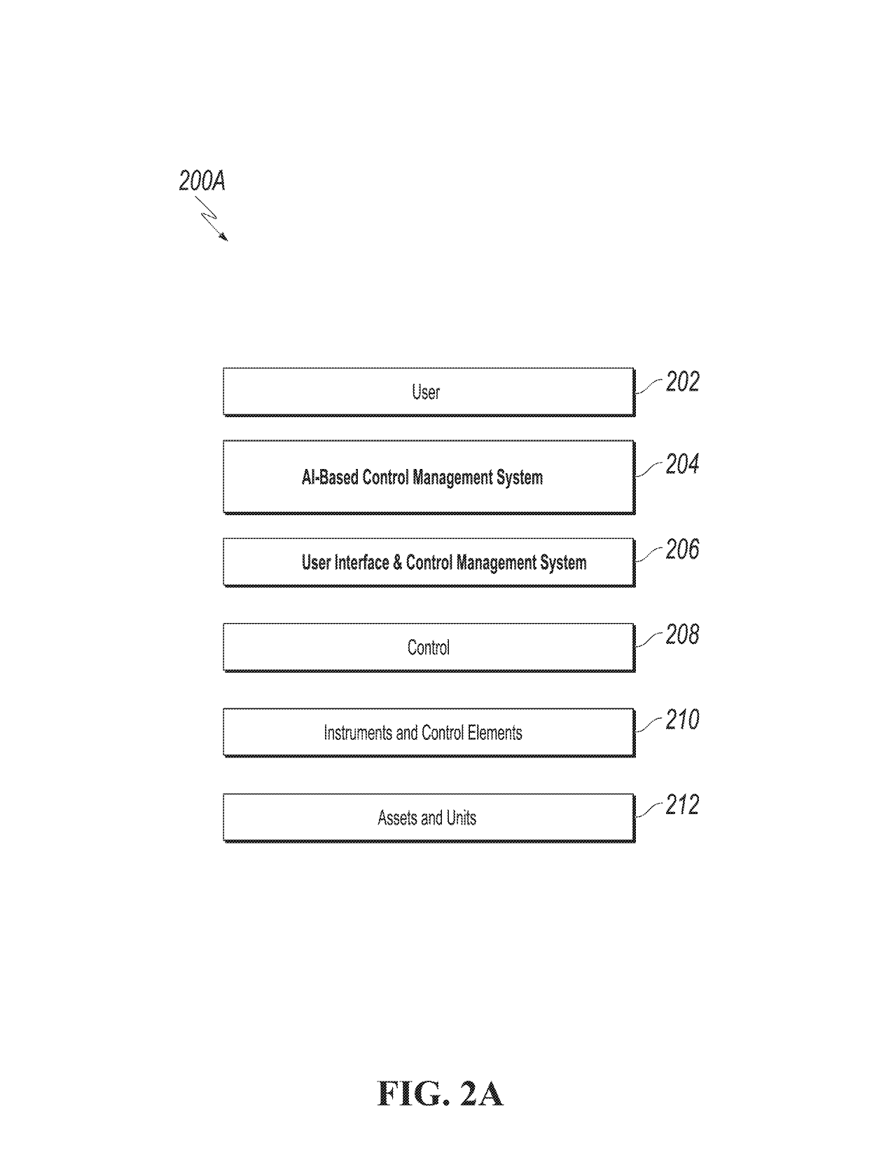

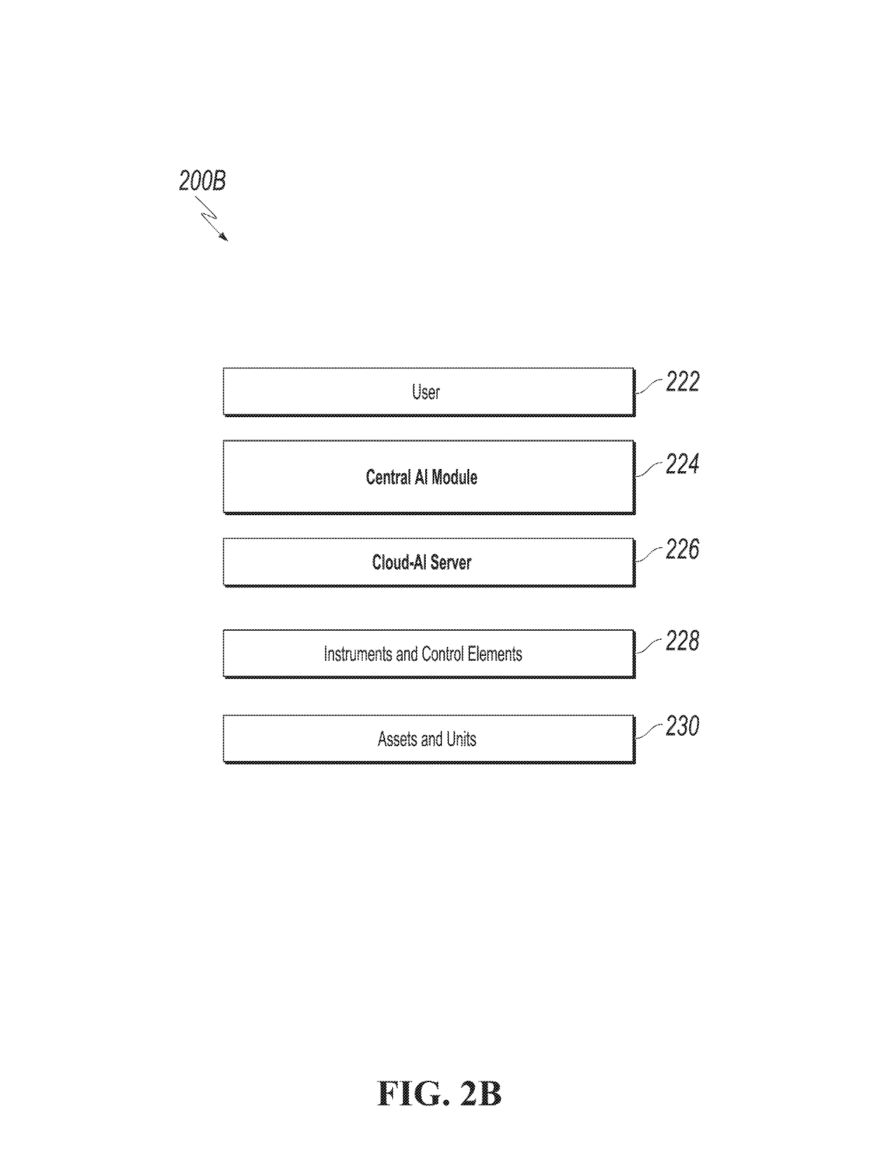

FIGS. 2A and 2B each illustrate an example protocol stack 200A and 200B, respectively, of a process control system in oil and gas infrastructure, according to some implementations. Protocol stacks 200A and 200B can be implemented in system 100, with some functions performed by cloud server 190, of FIG. 1.

In FIG. 2A, a process control system according to some implementations has user layer 202, AI-based control management system (AICMS) layer (or simply AI layer) 204, UI and control management system layer 206, control systems layer (or simply control layer) 208, instruments and control elements layer 210, and assets and units layer (or simply asset layer) 212.

Assets and units layer 212 serves as a foundational layer of the oil and gas infrastructure. Assets and units layer 212 has various assets and/or units that are involved in the processing of hydrocarbons and other materials. For example, assets and units layer 212 can include one or more NGL units, GOSP units, sulfur recovery units, and hydrocarbon dehydration units. Assets and units layer 212 can further include one or more supporting assets, such as boilers, heat exchangers, transformers, pipes, and storage tanks. These assets are involved in the primary operations of hydrocarbon processing and provide support to ensure seamless operation of a plant.

Instruments and control elements layer 210 has an array of instrumentation and control elements. The instrumentation includes a diverse array of devices and technologies, including sensors, pressure gauges, and devices for measuring flow rates and density levels. These instruments used in continuous monitoring and assessment of process variables, thereby enabling precise control over the operational parameters of the plant. The control elements are integral to the regulation of process conditions, such as valves, heaters, and switches, each designed to adjust operational variables in response to signals derived from the instrumentation. The relationship between instrumentation and control elements forms the basis for dynamic process adjustment, ensuring optimal performance and stability of plant operations. Thus, the instruments and control elements layer serve as an important interface between the physical processing assets and higher-level control systems, facilitating real-time management and adjustment of process variables.

Control systems layer 208 is tasked with the stabilization and management of control loops and process variables. For example, this layer integrates various instruments and final control elements through controllers or CPU modules that execute control schemes tailored to specific units within a plant. The control system, which can include a programable logic controller or a distributed control system (DCS), is pivotal in maintaining stable operations and ensuring that process variables are within desired parameters. Alternatively or additionally, this layer is responsible for the acquisition and storage of instrument readings and feedback control signals. The archival of the readings and signals allows for continuous monitoring, analysis, and optimization of plant operations. By providing a comprehensive repository of operational data, control systems layer 208 enables informed decision-making and facilitates the identification and resolution of potential issues, ensuring ongoing stability and efficiency of plant processes.

UI and control management system layer 206 encompasses a UI and a control management system to provide a centralized platform for the management of a plant's control systems and the utilization of operational data. For example, this layer provides the tools and interfaces used in the monitoring and management of plant operations, enabling the effective use of data in the strategic planning and optimization of future oil and gas plant operations. Through the deployment of UIs and management systems, this layer facilitates the interaction between human operators and the plant's control systems. By providing intuitive access to operational data and control functions, this layer empowers plant personnel to make informed decisions, optimize operational parameters, and implement strategic initiatives aimed at enhancing plant efficiency and productivity.

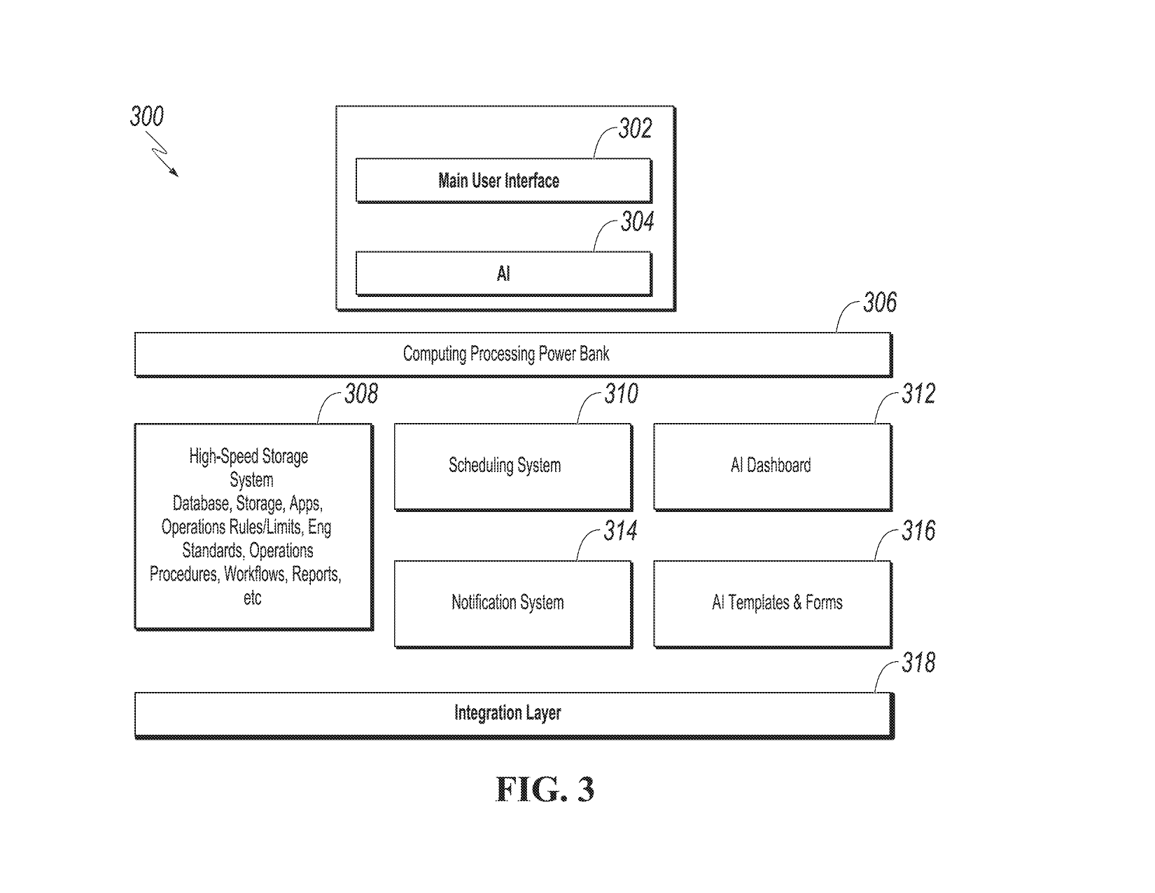

AI control management system layer 204 is a layer integrated with UI and control management system layer 206. AI control management system layer 204 can deploy AI applications to perform process control tasks specified by a user via the UI. These AI applications can be configured to perform activities traditionally done by expensive systems in the plants, such as those traditionally done by controllers and DCSs. These AI applications can also be configured to perform activities traditionally done by human, such as generating daily morning reports about the status of a plant. Details about the integration of AI control management system layer 204 with UI and control management system layer 206 are described later with reference to FIG. 3.

User layer 202 includes plant operators, maintenance teams, engineers, inspectors, and Health, Safety, and Environment (HSE) coordinators. Through the UI and the control management system, these individuals interact with various components of other layers, including units, assets, and control loops. Typically, users leverage the tools and information provided by the UI and the control management system to execute their roles effectively, ensuring safe, efficient, and compliant operations of the plant. Through interactions with the plant's operational systems, users embody the dynamic interface between technological systems and human expertise, thereby driving the continuous and reliable operations of oil and gas infrastructure.

In FIG. 2B, protocol stack 200B also has user layer 222, instruments and control elements layer 228, and assets and units layer 230, which are similar to user layer 202, instruments and control elements layer 210, and assets and units layer 212, respectively. Different from protocol stack 200A, protocol stack 200B has central AI module 224 and cloud-AI server 226. Central AI module 224 can be configured to run AI applications through forms and applications. Cloud-AI server 226 can be configured to implement the functions and capabilities of UI and control management system layer 206 of protocol stack 200A, as well as communication capabilities for central AI module 224 to communicate with field devices.

In some implementations, cloud-AI server 226 has one or more processors configured to run AI applications, including intelligent control and other AI functions, with central AI module 224. For example, when an application is a client-server application (e.g., an application having a client program that consumes services provided by a server program. The client requests services from the server by calling functions in the server application) involving AI forms, central AI module 224 can run the forms and applications as the server, whereas cloud-AI server 226 can run the forms and applications as the client.

In some implementations consistent with FIG. 2A, the protocol stack can be structured such as each of AI control management system layer 204 and UI and control management system layer 206 also has the capability to directly exchange data with user layer 202 and control layer 208. Likewise, in some implementations consistent with FIG. 2B, the protocol stack can be structured such as each of central AI module 224 and cloud-AI server 226 also has the capability to directly exchange data with user layer 222 and instruments and control elements layer 228. These direct connections allow AI control management system layer 204 and central AI module 224 to directly communicate with and control field devices of the oil and gas infrastructure, with the possibility of coordination with UI and control management system layer 206 and cloud-AI server 226.

In some implementations, the computing resources between central AI module 224 and cloud-AI server 226 can be allocated by, e.g., one or more processors.

FIG. 3 illustrates example architecture of AICMS 300, according to some implementations. AICMS 300 can be implemented to integrate AI control management system layer 204 and UI and control management system layer 206 of FIG. 2A.

AICMS 300 has a main UI 302 communicatively coupled to AI module 304. A user can provide commands through UI 302 to instruct AI module 304 to perform tasks in intelligent decision-making processes. AI module 304 can be configured to run one or more generative AI applications to parse the commands, obtain data from various data sources, execute the task according to the commands, and provide a response on UI 302. The commands can include, e.g., textual prompts in natural language.

AI module 304 can be configured to execute process control applications. For example, AI module 304 can access a suite of AI-Based process control applications developed to address specific operational needs, such as failure prediction, behavioral prediction of process variables (PVs), data insights, simulation, optimization studies, recommended setpoint adjustments, and operation decision-making. These applications are generally applicable to different assets of the same type in the plant, and/or applicable to assets across multiple plants belonging to the same system. Thus, there is no needed to build on separate AI-Based applications for different assets. Accordingly, these applications can leverage the categorized data for each asset, unit, or PV to deliver targeted insights and recommendations, enhancing operational efficiency and foresight. AI module 304 can run and utilize both AI-Based process control applications and traditional non-AI process control applications.

AICMS 300 has computing power bank 306, which can be a computing resource bank supporting powering the AI applications. When multiple applications are executed or multiple resources are available, modules such as cloud management module 172 of cloud-AI server 190 can allocate resources from the computing resource bank to the applications.

AICMS 300 has highspeed storage system 308, which can be tasked with, e.g., secure retention of data to facilitate historical data analysis and archival functions. Storage system 308 also can store data, such as code and parameters, of all the process control applications. Storage system 308 operates to maintain a comprehensive repository of operational rules and operations limits, which can be useful for trend analysis, reporting, and training the AI module. Storage system 308 can be a separate element from the data historian of a plant. Plant data and operation data are accessed through integration layer 318, described later, to perform analysis and updates.

AICMS 300 has integration layer 318 configured to aggregate data from different data sources. These data sources can include, e.g., plant data historian, DCS data storage, instrumentation data, maintenance records, inspection reports, HSE data, laboratory results, and asset/plant state information. The data from each source can be categorized per asset, unit, or process variable, which are available at the APP storage 160 and OPS storage 162 of FIG. 1. Each piece of data can be time-stamped to ensure a cohesive and structured data framework. As such, the interconnections between various data sources and instruments form a digital nervous system for the plants, which can bring about enhanced control, operational efficiency, and intelligent response to dynamic conditions in the oil and gas infrastructure.

Integration layer 318 can be configured to interface seamlessly with an array of data sources to enhance the operational intelligence of oil and gas plants and the cloud-AI server 190 . By establishing direct connections with these data sources, integration layer 318 creates a robust foundation for advanced AI applications, advanced analytics, and decision-making. Integration layer 318 can communicate with the data sources using wireless or wired connections.

For example, integration layer 318 taps into the plant's data historian to aggregate and analyze historical operational data. This enables pattern recognition and predictive insights that can foresee potential issues and inform proactive maintenance strategies. By integrating AI module 304 with data such as maintenance data, inspection data, lab data, HSE data, and/or DCS data, integration layer 318 ensures that real-time operational data is harnessed and creates data synergy, thereby allowing for the synchronization of control strategies with actual plant conditions.

Likewise, integration layer 318 further integrates AI module 304 with data from devices, assets, instruments, sensors, actuators, valves, or other components of the oil and gas infrastructure. This integration can offer precise real-time measurements for maintaining optimal conditions. For example, using asset and plant state information, AI module 304 can provide a comprehensive view of the plant's health, empowering asset lifecycle management and strategic planning.

AICMS 300 has scheduling system 310 configured to orchestrate the timing of activities, notifications, and the generation of reports. By ensuring structured scheduling, scheduling systems 310 facilitates the orderly execution of operational tasks and the timely dissemination of information, supporting efficient workflow management.

AICMS 300 has notification system 314 configured to alert users of critical information, including high-priority items, discrepancies in records, and operational reports (e.g., daily reports). Notification system 314 enhances communication and operational awareness among stakeholders, promoting timely decision-making and response to operational dynamics.

AICMS 300 has one or more AI dashboards 312 configured to provide a visual interface for real-time monitoring and reporting. AI dashboards 312 can be categorized by roles (management, plant units, or organization), disciplines (operators, engineers, inspectors, maintenance personnel, etc.), plant sections (per plant units or asset types), and types (live dashboards, daily reports, monthly reports, etc.), offering a personalized and efficient way to access critical information and insights.

AICMS 300 has AI templates and forms 316. Using these templates and forms, a user can communicate with AI-CMS and to interact with the oil and gas infrastructure. For example, the forms can have text prompts and various types of menus to determine what assets to control, what process control applications to execute, what operational data to use, and what outcomes are needed.

An example of controlling a boiler in a plant is provided below to illustrate the operations of AICMS 300. Typically, the boiler is controlled in a closed loop with parameters such as: current steam pressure, desired steam pressure, fuel flow rate, heat input rate, feed water flow rate, temperature of feed water, temperature of steam, and quality of steam (moisture content). An assumption for the control is that the primary purpose of the boiler is to produce steam at a certain pressure and temperature for use in various processes within the oil and gas plant, and the control system is designed to maintain the steam pressure at a setpoint required for the process. The example also assumes that sensors and actuators are installed and functioning properly.

In existing process control systems not supported by AI, the control requires an operator to establish the setpoint at, e.g., 150 PSI of steam pressure. The actual steam pressure is continuously measured by the pressure sensor and transmitted to the controller, which adjusts the fuel flow rate based on whether the measured pressure is above or below the desired pressure. This process of feedback continues to ensure the actual steam pressure remains at the desired level.

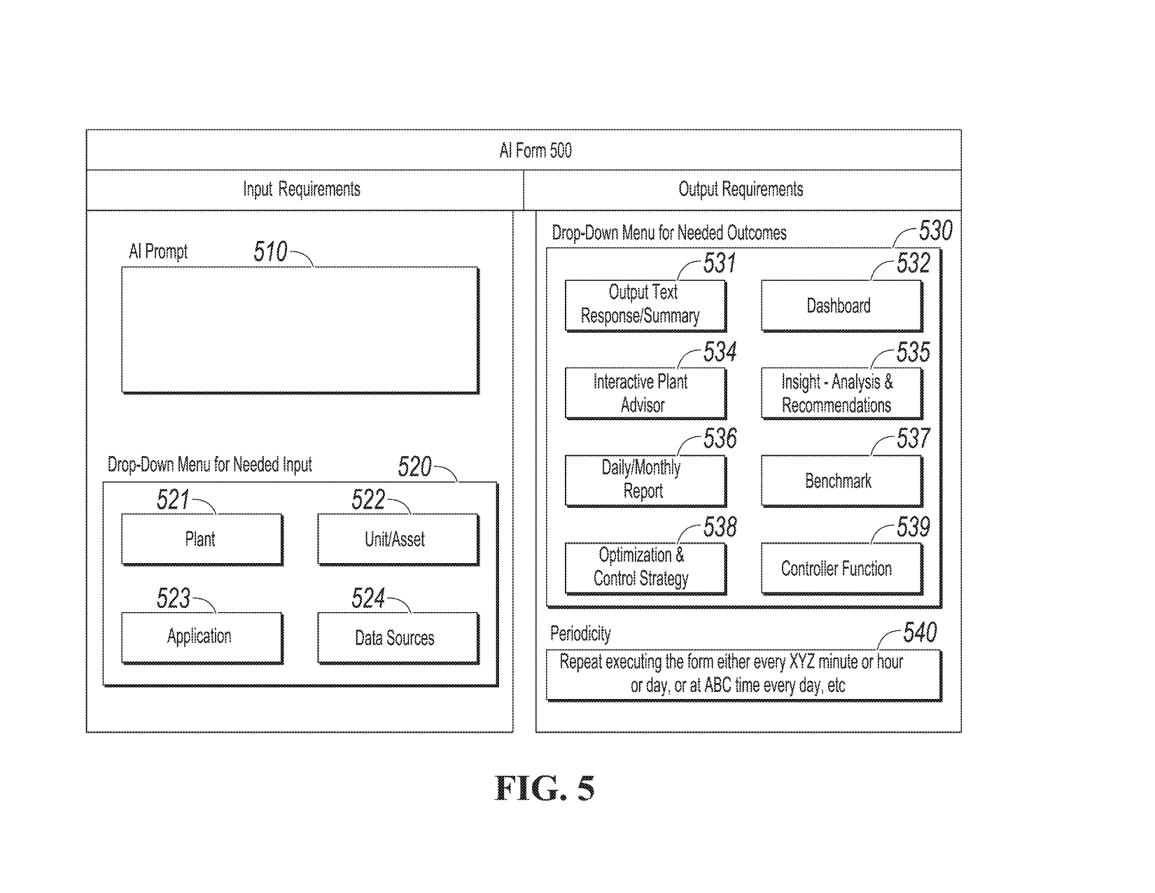

In some implementations, AI module 304 can simplify the process control. For example, a user can provide, through a UI coupled to a cloud server, a prompt in natural language to AI module 304 using a form 316, instructing AI module 304 to “operate a closed-loop control system for a steam boiler.” The user can also provide other criteria in natural language to provide AI module 304 with, e.g., the goals of the control, the conditions and limitations of operations, the allowed range of adjustment, and/or the periodicity of monitoring and adjustment. In return, AI module 304 can parse the instructions, extract control parameters from the instructions, and obtain asset-specific information and application-specific information needed to perform the task. Upon performing the task, AI module 304 can output, on UI 302 and in natural language, control information to keep the user updated of the status of the operations, such as the actual steam pressure last measured, the adjustment last taken, and/or the next planned measurement. AI module 304 can also automatically send control signals to the boiler and other equipment to carry out the measurements and adjustments, and automatically generate a notification signal to report the control status. This way, the process control can be largely automated with high level of intelligence and reduced likelihood of failure. The user-AI interactions can utilize one or more forms or templates from AI templates and forms 316 and as described below with reference to FIG. 5. This form for boilers can further be reused to other boilers in the plants with minor differences in setpoints value or different step sizes.

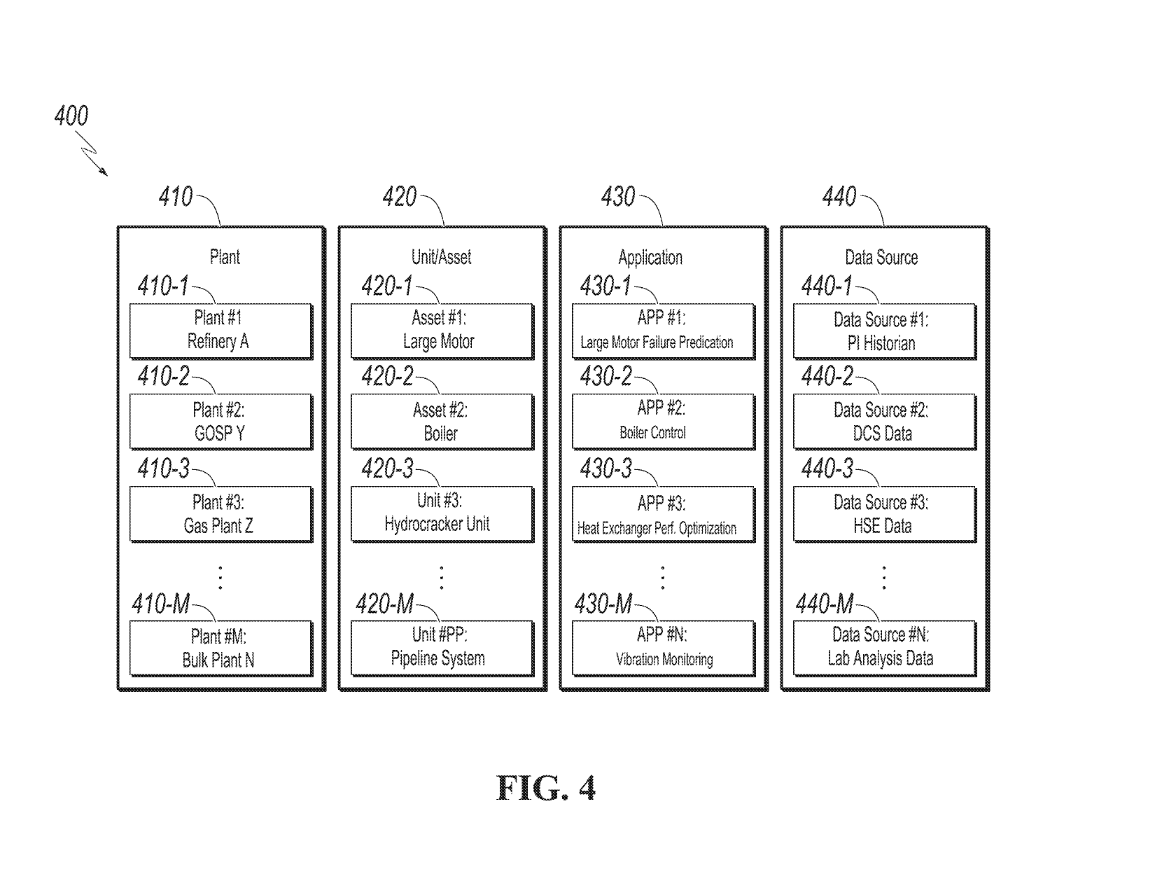

FIG. 4 illustrates an example matrix 400 in a form to be displayed on a UI of a process control system, such as the process control system described with reference to FIGS. 1-3, according to some implementations. As illustrated, matrix 400 has four columns: Plant 410, Unit/Asset 420, Application 430, and Data Source 440.

Plant 410 lists available plants 410-1 to 410-M that a user can select to control. As illustrated, example plants on the list include a refinery, a GOSP unit, a gas plant, and a bulk plant.

Unit/Asset 420 lists available units and assets 420-1 to 420-M that a user can select to control. As illustrated, example units and assets on the list include a large motor, a boiler unit, a hydrocracker unit, and a pipeline system.

Application 430 lists available process control applications 430-1 to 430-M that a user can select to execute based on, e.g., comparing one or more process conditions (such as those read by field sensors) with a setpoint provided in the instruction. For instance, when a difference between the setpoint and the actually measured output is larger than a threshold, one or more applications can be executed based on a textual prompt-based control loop.

In some implementations, the performance of application is based on the textual prompt control on two or more process variables in a multi-variable control system, e.g., for conducting simultaneous control for that asset or unit.

In some implementations, the performance of application is based on the textual prompt control on multiple correlated setpoints and multiple correlated outputs.

In some implementations,

In some implementations, the performance of application is based on the textual prompt control on any asset.

In some implementations, two processors executing applications based on separate prompts can communicate with each other.

The listed applications 430-1 to 430-M can be AI-based control applications or non-AI traditional control applications. As illustrated, example process control applications on the list include large motor failure prediction, boiler control for certain types of boilers, heat exchanger performance optimization, and vibration monitoring. Process control applications 430-1 to 430-M can be selectively executed to control some plants, units, and assets listed in columns 410 and 420. The AI can run multiple AI-based applications, multiple non-AI-based applications, or a combination of AI-Based and non-AI-based applications on the same asset or unit. For example, AI can run AI-based Application #1 (which could be a method for predicting the failure) and AI-based Application #2 (which could be a different method for predicting the failure), and then the AI will take either the average or the more conservative scheme. Furthermore, The AI can run multiple AI-Based applications and non-AI application on the same asset or unit.

Data source 440 lists sources of input data 440-1 to 440-M that a user can select for a process control application to use. As illustrated, example data sources on the list include plant information (PI) historian, DCS data, HSE data, and lab analysis data. Using data from selected data sources, a selected process control application can deploy AI to control the selected plant, unit, and/or asset.

One or more data sources may be selected to provide data for a process control application, and one or more process control applications may be executed to control a plant, unit, or asset. When a user specifies a process control task to be performed by AI, one or more plants, units, or assets may be controlled in the same task.

FIG. 5 illustrates example content displayed on a UI, according to some implementations. The content displayed is organized according to AI form 500, which can be a form from AI templates and forms 316 of FIG. 3.

As illustrated, AI form 500 has a region to specify input requirements and a region to specify output requirements. In the input requirements, the user can provide AI prompt 510 in text of natural language or according to other formats. The user can also select, from a group of drop-down menus 520, which plants 521 to control, which units/assets 522 to control, which process control applications to execute, and/or which data sources to obtain from. Drop-down menus 520 can correspond to matrix 400 of FIG. 4.

In the output requirements, the user can select, from a group of drop-down menus 530, what type of response or summary 531 to display, which dashboard 532 to use, which interactive plant advisor 534 to consult, what type of insight or analysis recommendation 535 to receive, whether to receive daily or monthly reports 536, what benchmark 537 to use, what optimization and control strategy 538 to adopt, and/or what controller function to perform. The user can also specify a periodicity, e.g., in seconds, minutes or days, for the AI module to regularly perform the task according to the input and output requirements.

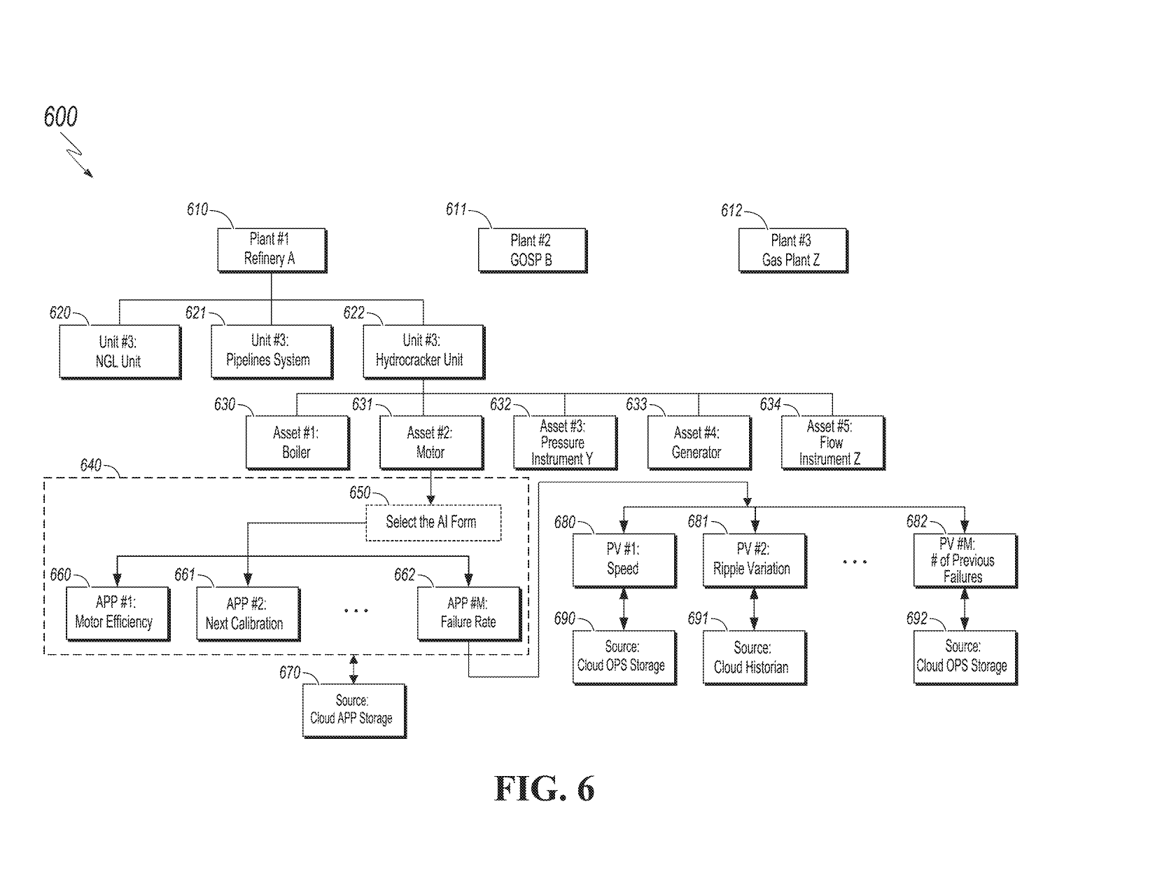

FIG. 6 illustrates an example database structure 600 in a process control system, according to some implementations, such as those illustrated in FIG. 4. Database structure 600 can be implemented within or coupled to a cloud server, such as cloud-AI server 190, to carry out the control operations described above with reference to FIGS. 3-5. For example, database structure 600 can store matrix 400 of FIG. 4. Based on the task specified in the AI prompt 510 of FIG. 5, database structure 600 can locate the needed data from data sources, match the data to the specified plants, units, or assets, and supply the data to the process control applications deployed for performing the task.

At each level (e.g., plant, unit, or asset) of the oil and gas infrastructure, data are stored per subset at that level. As illustrated, database structure 600 has blocks 610-612 to store data that are specific to plants #1-#3, respectively, with each plant being a subset at the plant level. For units within plant #1, database structure 600 has blocks 620-622 to store data that are specific to units #1 to #3, respectively, with each unit being a subset at the unit level. Furthermore, for assets within unit #3, database structure 600 has blocks 630-634 to store data that are specific to assets #1 to #5, respectively, with each asset being a subset at the asset level. The subset-specific data can be referred to as first data and can include, e.g., process conditions corresponding to the subset of the oil and gas infrastructure. For each subset, the corresponding first data can indicate, e.g., the operations status of the asset, e.g., the temperature, pressure, flowrate, and/or maintenance records of the asset.

Database structure 600 also stores a suite of process control applications 610. After a user selects an AI form and provides input and output requirements for a task at 650, database structure 600 can perform application data analysis based on the user’s instruction and/or operations rules or limits. For example, when the user instructs the AI module to track the status and conduct maintenance of a motor of asset 631, database structure 600 can determine that process control applications 660-662 are to be executed for the task. Database structure 600 then accesses cloud APP storage 670, which can be similar to APP storage 160 of FIG. 1, to obtain data that are specific to process control applications 660-662, which can be AI-based. These data can be referred to as second data. Second data can include the source code or executables of process control applications 660-662, as well as configurations and supporting files for process control applications 660-662. Second data can also include historical information (e.g., historical computing resource allocation) of executing the process control application corresponding to the process control application.

Each AI-based process control application can further obtain one or more PVs from the cloud storage. For example, assuming the task specified by the user at 650 involves failure rate prediction for asset 631, database structure 600 can access cloud OPS storage 690 and cloud historian 691 to obtain PVs 680-682 (speed, ripple variation, and number of previous failures) needed for failure rate prediction. OPS storage 690 and cloud historian 691 can be similar to OPS storage 162 and cloud historian 164, respectively, or FIG. 1. The PVs can also be application-specific, e.g., applicable to one or more applications for the same type of assets, and can be included as second data.

As described above, when an AI module performs a task by executing one or more process control applications, a processor of a cloud server can access database structure 600 to obtain first data and second data from different data sources. The integration layer of the process control system can aggregate these data such that the process control applications are particularly applied to the subset of oil and gas infrastructure according to the user’s instruction. Because the second data including the process control applications and the PVs are stored in database structure 600 on the cloud instead of locally at each subset, the process control applications and the PVs can be reused for different subsets based on the subset-specific first data, thereby simplifying the process control and increasing system scalability.

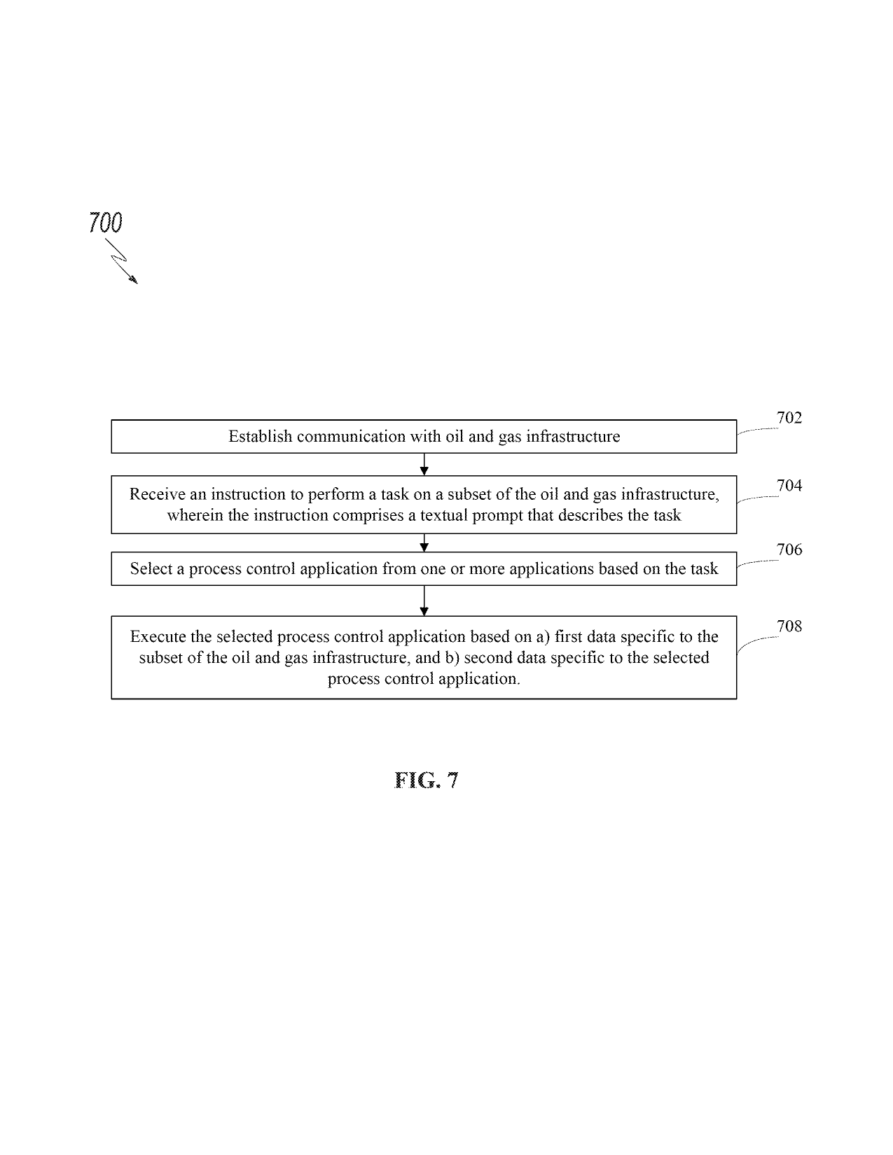

FIG. 7 illustrates a flowchart of an example method 700, according to some implementations. Method 700 can be performed by, e.g., process control system 100 of FIG. 1.

At 702, method 700 involves establishing communication, e.g., via universal gateway 120 of FIG. 1, with oil and gas infrastructure.

At 704, method 700 involves receiving an instruction to perform a task on a subset of the oil and gas infrastructure. The instruction includes a textual prompt, such as AI prompt 510 of FIG. 5, that describes the task. The textual prompt can include one or more of: a prompt in natural language, a flowchart, computer program code, a lookup table (e.g., one indicating a function of the setpoint an actual process value, or an input setup size), an initiation of an alarm message, a prediction of failure (e.g., failure rate, failure time, recommended future maintenance, and future conditions), or a process control application (or a condition that triggers behavior corresponding to an application).

At 706, method 700 involves selecting a process control application from one or more process control applications based on the task. The selected process control application can be any of process control applications 660-662 of FIG. 6.

At 708, method 700 involves executing the selected process control application based on a) first data specific to the subset of the oil and gas infrastructure, and b) second data specific to the selected process control application.

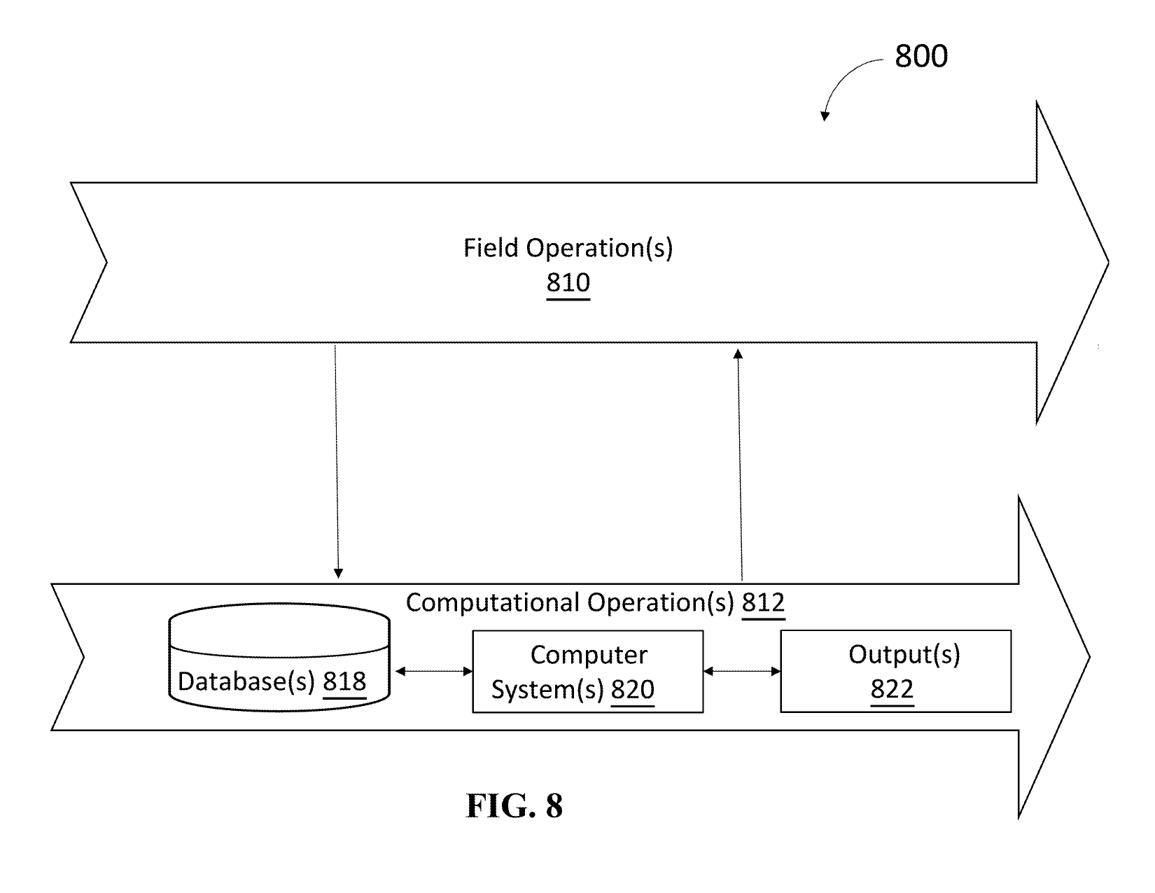

FIG. 8 illustrates hydrocarbon production operations 800 that include both one or more field operations 810 and one or more computational operations 812, which exchange information and control exploration for the production of hydrocarbons. In some implementations, outputs of techniques of the present disclosure (controlling a subset of oil and gas infrastructure) can be performed before, during, or in combination with the hydrocarbon production operations 800, specifically, for example, either as field operations 810 or computational operations 812, or both.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively, or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual’s action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

### Examples

In an example implementation, a control system comprises: a cloud server comprising a processor; a network gateway configured to communicatively couple the cloud server to oil and gas infrastructure; and a user interface (UI). The processor is configured to perform one or more artificial intelligence (AI)-based control operations comprising: receiving an instruction from the UI to perform a control task on a subset of the oil and gas infrastructure according to a process condition, wherein the instruction comprises a textual prompt that describes the control task; selecting a process control application from one or more process control applications based on the a comparison of the process condition with a setpoint; and executing the selected process control application based on i) first data comprising the process condition specific to the subset of the oil and gas infrastructure, and ii) second data specific to the selected process control application.

In an aspect combinable with the example implementation, the process condition comprises information indicating an operation status of the subset of the oil and gas infrastructure.

In another aspect combinable with any of the previous aspects, the second data comprises at least one of: a process variable of the selected process control application, or historical information of executing the selected process control application.

In another aspect combinable with any of the previous aspects, the textual prompt comprises at least one of: a prompt in natural language, a flowchart, computer program code, a lookup table indicating a function of the setpoint an actual process value, or an input setup size, an initiation of an alarm message, a prediction of failure, or a process control application.

In another aspect combinable with any of the previous aspects, the processor is configured to perform the control task periodically.

In another aspect combinable with any of the previous aspects, the instruction comprises a selection of at least one of: a process plant, a process asset, a process unit, the process control application, or data sources of the first data and the second data.

In another aspect combinable with any of the previous aspects, the control system further comprises an artificial intelligence (AI) model communicatively coupled to the cloud server and configured to perform the AI-based control operations. To execute the selected process control application, the processor is configured to provide the instruction to the AI model and receive an output from the AI model.

In another aspect combinable with any of the previous aspects, the AI model is configured to: receive the instruction from the cloud server; extract one or more control parameters from the instruction; obtain at least one of the first data or the second data based on the one or more control parameters; and generate the output based on the at least one of the first data, the second data, or the setpoint.

In another aspect combinable with any of the previous aspects, the control system further comprises an integration layer communicatively coupled to a plurality of data sources. The integration layer is configured to: obtain the first data from the plurality of data sources; match the first data with the subset of the oil and gas infrastructure; timestamp the first data; and provide the first data to the AI model.

In another aspect combinable with any of the previous aspects, the plurality of data sources comprise at least one of: a sensor attached to the oil and gas infrastructure, a data historian of the oil and gas infrastructure, an distribution control system data storage, an instrumentation data storage, a maintenance records storage, an inspection reports storage, a health, safety and environment (HSE) data storage, a laboratory results storage, or an infrastructure state information storage.

In another aspect combinable with any of the previous aspects, the control system further comprises a database communicatively couple to the cloud server. The database is configured to: store the one or more applications; perform application data analysis and prediction based on at least one of: one or more operation rules, or one or more operation limits; generate the second data based on the application data analysis and prediction; and provide the second data to the AI model.

In another aspect combinable with any of the previous aspects, the output comprises at least one of: a textual response to be displayed on the UI, a control signal to be sent to the subset of the oil and gas infrastructure, or a notification signal.

In another aspect combinable with any of the previous aspects, the processor is configured to allocate computing resources from a computing resource bank to the AI model.

In another aspect combinable with any of the previous aspects, the processor is configured to execute a virtual function on the cloud server to perform load balancing on the oil and gas infrastructure.

In another aspect combinable with any of the previous aspects, the processor is configured to execute a virtual function on the cloud server to schedule performance of the task.

In another aspect combinable with any of the previous aspects, the processor is configured to execute a virtual function on the cloud server to perform the task according to a security policy.

In another aspect combinable with any of the previous aspects, the control system further comprises a communication bus communicatively coupled to the network gateway, the cloud server, and the UI.

In another aspect combinable with any of the previous aspects, the processor is configured to select a display form on the UI.

Any of the above aspects can be implemented as a method or as operations performed by a processor when executing instructions stored in a non-transitory computer-readable medium.

While this specification includes many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

What is claimed is:

1. A control system comprising:
a cloud server comprising a processor;
a network gateway configured to communicatively couple the cloud server to oil and gas infrastructure; and
a user interface (UI),
wherein the processor is configured to perform one or more artificial intelligence (AI)-based control operations comprising:
receiving an instruction from the UI to perform a control task on a subset of the oil and gas infrastructure according to a process condition, wherein the instruction comprises a textual prompt that describes the control task;
selecting a process control application from one or more process control applications based on the a comparison of the process condition with a setpoint; and
executing the selected process control application based on i) first data comprising the process condition specific to the subset of the oil and gas infrastructure, and ii) second data specific to the selected process control application.

2. The control system of claim 1, wherein the process condition comprises information indicating an operation status of the subset of the oil and gas infrastructure.

3. The control system of claim 1, wherein the second data comprises at least one of:
a process variable of the selected process control application, or
historical information of executing the selected process control application.

4. The control system of claim 1, wherein the textual prompt comprises at least one of:
a prompt in natural language,
a flowchart,
computer program code,
a lookup table indicating a function of the setpoint an actual process value, or an input setup size,
an initiation of an alarm message,
a prediction of failure, or
a process control application.

5. The control system of claim 1, wherein the processor is configured to perform the control task periodically.

6. The control system of claim 1, wherein the instruction comprises a selection of at least one of: a process plant, a process asset, a process unit, the process control application, or data sources of the first data and the second data.

7. The control system of claim 1, further comprising an artificial intelligence (AI) model communicatively coupled to the cloud server and configured to perform the AI-based control operations, wherein, to execute the selected process control application, the processor is configured to provide the instruction to the AI model and receive an output from the AI model.

8. The control system of claim 7, wherein the AI model is configured to:
receive the instruction from the cloud server;
extract one or more control parameters from the instruction;
obtain at least one of the first data or the second data based on the one or more control parameters; and
generate the output based on the at least one of the first data, the second data, or the setpoint.

9. The control system of claim 8, further comprising an integration layer communicatively coupled to a plurality of data sources, wherein the integration layer is configured to:
obtain the first data from the plurality of data sources;
match the first data with the subset of the oil and gas infrastructure;
timestamp the first data; and
provide the first data to the AI model.

10. The control system of claim 9, wherein the plurality of data sources comprise at least one of:
a sensor attached to the oil and gas infrastructure,
a data historian of the oil and gas infrastructure,
an distribution control system data storage,
an instrumentation data storage,
a maintenance records storage,
an inspection reports storage,
a health, safety and environment (HSE) data storage,
a laboratory results storage, or
an infrastructure state information storage.

11. The control system of claim 8, further comprising a database communicatively couple to the cloud server, wherein the database is configured to:
store the one or more applications;
perform application data analysis and prediction based on at least one of: one or more operation rules, or one or more operation limits;
generate the second data based on the application data analysis and prediction; and
provide the second data to the AI model.

12. The control system of claim 7, wherein the output comprises at least one of:
a textual response to be displayed on the UI,
a control signal to be sent to the subset of the oil and gas infrastructure, or
a notification signal.

13. The control system of claim 7, wherein the processor is configured to allocate computing resources from a computing resource bank to the AI model.

14. The control system of claim 1, wherein the processor is configured to execute a virtual function on the cloud server to perform load balancing on the oil and gas infrastructure.

15. The control system of claim 1, wherein the processor is configured to execute a virtual function on the cloud server to schedule performance of the task.

16. The control system of claim 1, wherein the processor is configured to execute a virtual function on the cloud server to perform the task according to a security policy.

17. The control system of claim 1, further comprising a communication bus communicatively coupled to the network gateway, the cloud server, and the UI.

18. The control system of claim 1, wherein the processor is configured to select a display form on the UI.

19. A method comprising:
establishing communication with oil and gas infrastructure;
receiving an instruction to perform a control task on a subset of the oil and gas infrastructure according to a process condition, wherein the instruction comprises a textual prompt that describes the control task;
selecting a process control application from one or more process control applications based on the control task; and
executing the selected process control application based on a) first data comprising the process condition specific to the subset of the oil and gas infrastructure, and b) second data specific to the selected process control application.

20. A non-transitory computer-readable medium storing program instructions that, when executed, cause a processor to perform operations comprising:
establishing communication with oil and gas infrastructure;
receiving an instruction to perform a control task on a subset of the oil and gas infrastructure according to a process condition, wherein the instruction comprises a textual prompt that describes the control task;
selecting a process control application from one or more process control applications based on the control task; and
executing the selected process control application based on a) first data specific to the subset of the oil and gas infrastructure, and b) second data specific to the selected process control application.
